(19) United States
(12) Patent Application Publication
(10) Pub. No.: US 2026/0307923 A1
(43) Pub. Date: Oct. 8, 2026

(54) A SINGULARIZED BLISTER UNLOADING SYSTEM

(71) Applicant: MARCHESINI GROUP S.P.A., Pianoro (Bologna) (IT)

(72) Inventor: Simone NANNETTI, Pianoro (Bologna) (IT)

(21) Appl. No.: 19/476,358

(22) PCT Filed: Feb. 14, 2024
(86) PCT No.: PCT/IB2024/051382

§ 371 Date: Oct. 17, 2025

(30) Foreign Application Priority Data
Jun. 28, 2023 (IT) 102023000013410

(51) Int. Cl. B65G 59/06; B65B 35/02

(52) U.S. Cl. CPC B65G 59/062; B65B 35/02; B65G 2201/0235; B65G 2814/0308

(57) ABSTRACT

The invention is an unloading system (1) suitable for performing a singularized unloading operation of a blister (90) comprising: i) a blister storage column (2) that extends along a vertical axis (V-V) in which a column of vertically stacked blisters (900), each parallel to a respective imaginary plane, is housable, wherein the blister storage column (2) comprises a bottom region (20) in which the column of blisters (900) comprises a last blister (90a) and a second-last blister (90b); ID a pair of unloading assemblies (3) that extend and operate transversely opposed with respect to the vertical axis (V-V), wherein each unloading assembly (3) comprises:—a blade group (41, 42) transversely movable along a transverse axis (X-X) suitable for engaging the last blister (90a) comprising a movement device (412, 422) and a blade element (411, 421) suitable for engaging a blister and engaged with an end of the respective movement device (412, 422);—control group (5) operatively connected to an end of the movement device (412, 422), which transversely moves the movement device (412, 422) so as to position the blade element (411, 421) in a position in which the blister is disengaged and thus free to fall vertically, and a position in which the blister pack is engaged and held in a respective vertical axial position;—a safety group (6) suitable for disengaging the blade group (4) from the control group (5) by positioning the blade element (411, 421) in a transverse position in which it engages with the blister.

The present invention is in relation to an unloading system suitable for performing a singularized unloading operation of a blister. Additionally, the present invention is in relation to a blister packaging machine that comprises said unloading system.

Known in the state of the art are blister packaging machines that are suitable for performing a series of operations and possibly enclosing and/or boxing blisters in cartons or boxes. Specifically, “blisters” are those packages that, within special alveoli, contain specific products, for example pharmaceutical type products such as capsules, tablets or similar products. The definition “blister” in this discussion is not limited to the type of products contained within the respective alveoli which may, for example, contain syringes, vials etc.

Specifically, known blister packaging machines comprise a station comprising an unloading system that is suitable for unloading a singularized blister onto a conveyor belt.

Preferably, in known unloading systems, there is included an accumulation system and specific discharge assemblies that are suitable for controlling the movement, or for enabling the movement, of a blister towards the conveyor belt.

Unloading systems are known using rotating unloading assemblies, wherein the blister is unloaded at a specific angle, whilst at other angular positions the blister is held in position.

Such unloading systems present various issues: they require the correct positioning of the blister, which instead may not always be ensured, which may result in being, for example, inclined or bent, occasionally causing the unloading system to become blocked; these are systems of limited versatility that are suitable for operating with specific types of blister and not with a multiplicity of blisters of varying shapes and dimensions.

Furthermore, unloading systems are known with unloading assemblies comprising pneumatic manipulators that are suitable for picking up a blister and unloading it to a preferred location and in a preferred way. These solutions are more versatile but are extremely complex both as regards the implementation and management thereof.

The object of the present invention is that of effectively resolving the aforesaid situation in proposing an unloading system that is suitable for performing a singularized unloading operation of a blister in avoiding the aforesaid issues. In other words, the object of the present invention is that of providing an unloading system with a simple geometry, simple management and elevated flexibility that is suitable for performing singularized unloading operations of a blister that are reliable and safe.

Such object is achieved by mean of the unloading system claimed in claim 1. Additionally, such object is achieved by the blister packaging machine according to claim 12. The claims dependent on these request protection for further features and entail further technical benefits.

In addition, further features and advantages of the invention will become clear from the description provided below of the preferred embodiments thereof given as non-limiting examples in reference to the attached figures, wherein:

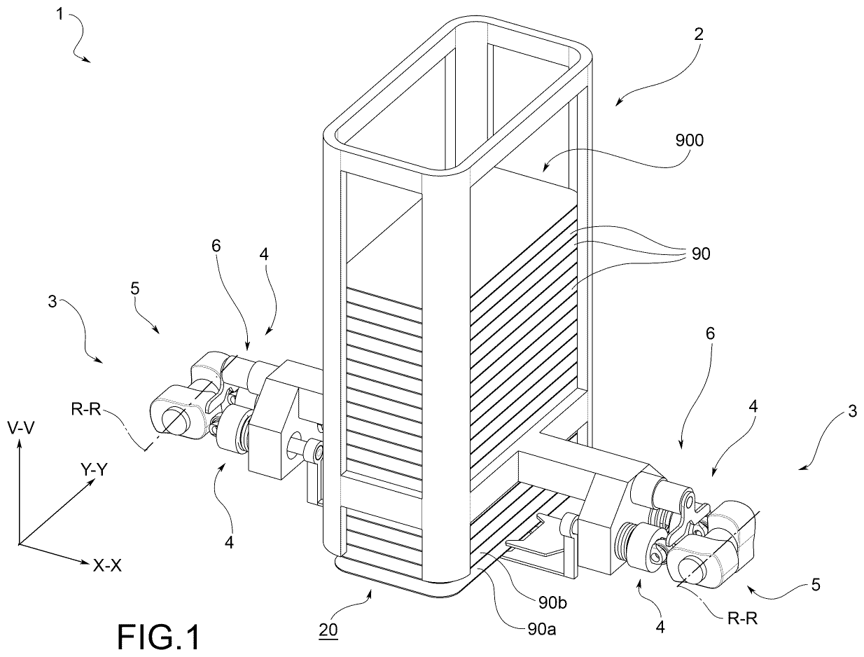

FIG. 1 shows a perspective view of an unloading system according to the present invention, in accordance with a first embodiment;

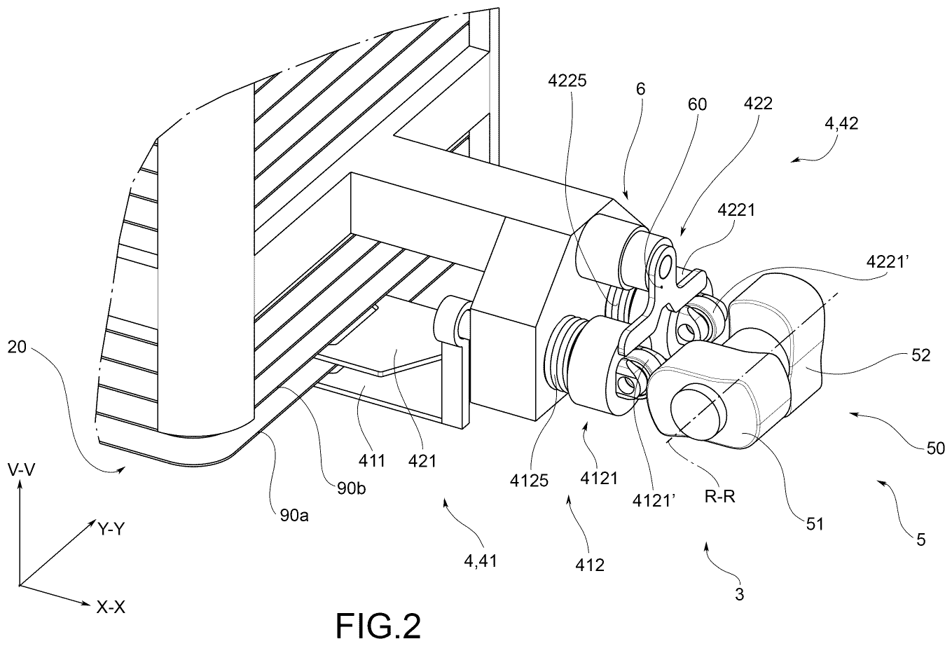

FIG. 2 is an enlarged view of a portion of FIG. 1;

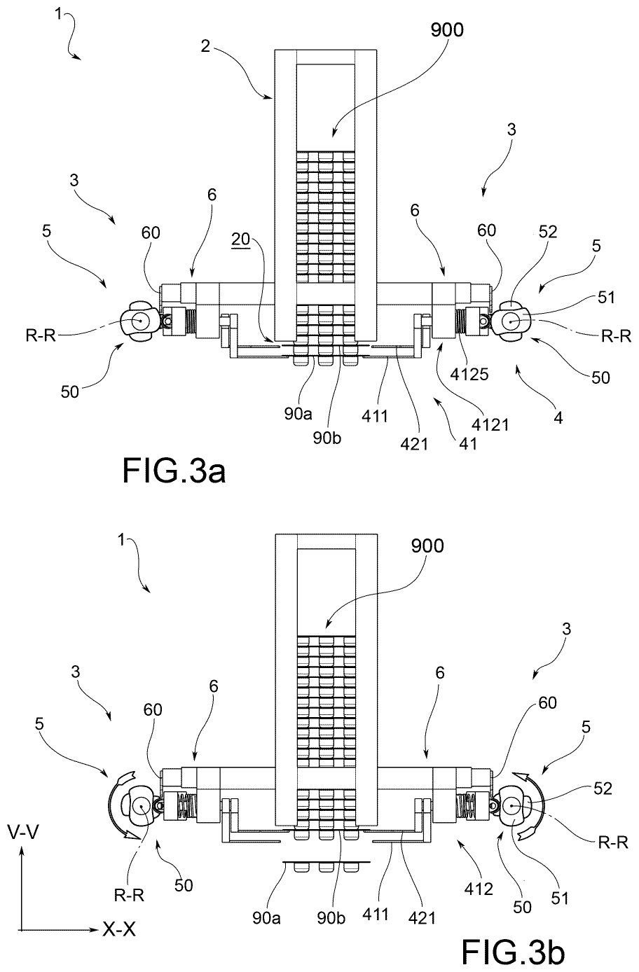

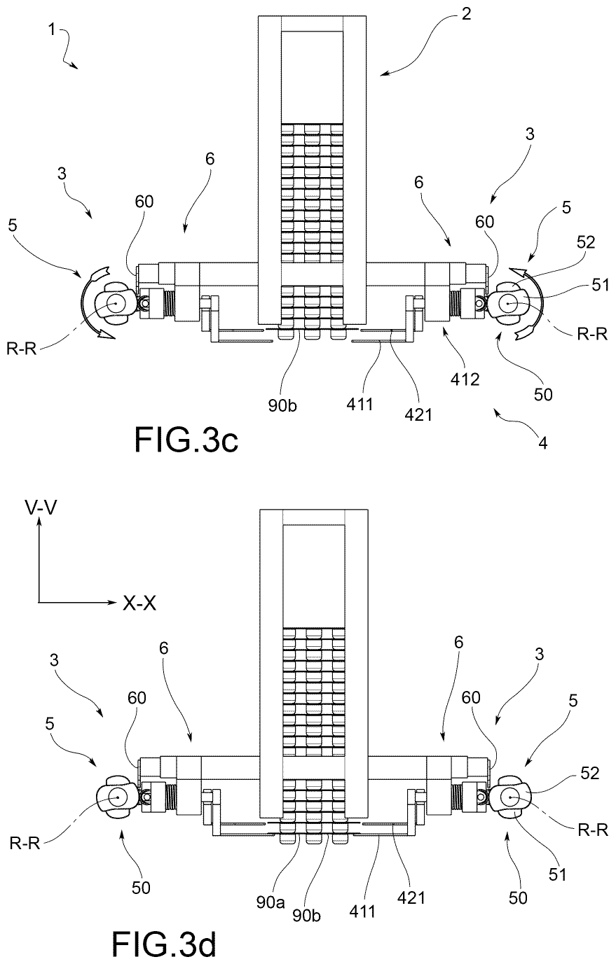

FIGS. 3a, 3b, 3c and 3d show, respectively, front views of the unloading system of FIG. 1, representing the steps of a blister unloading cycle;

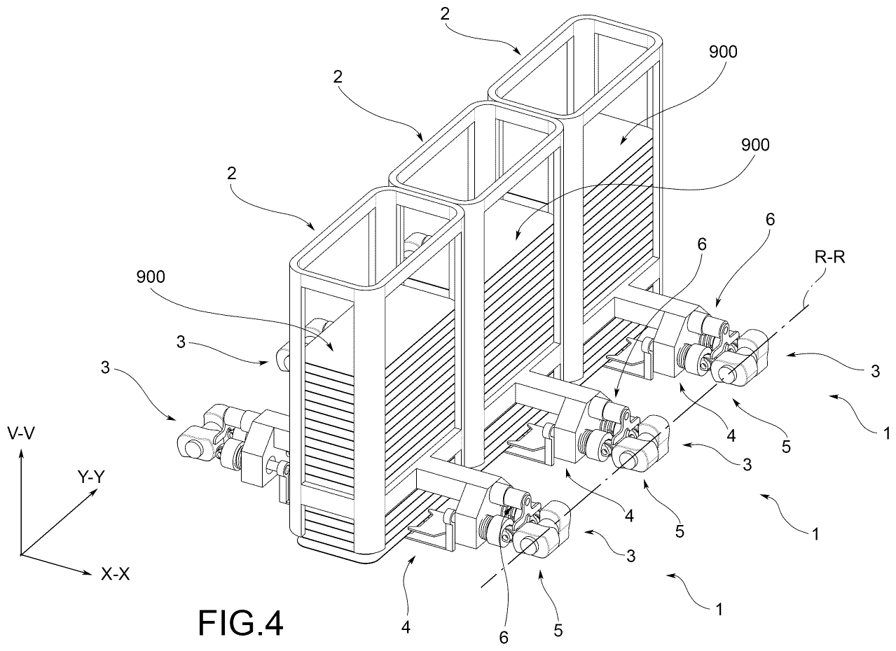

FIG. 4 shows a portion of a blister packaging machine that comprises a plurality of unloading systems in parallel.

In the accompanying figures the reference numeral 1 shows an unloading system according to the present invention.

The unloading system 1 is suitable for performing a singularized unloading operation of a blister 90, for example onto a conveyor belt. The unloading system 1 is suitable for performing a multiplicity of singularized unloading operations of a blister 90, for example onto a conveyor belt continuously.

As a matter of fact, the unloading system 1 comprises a blister storage column 2 and a pair of unloading assemblies 3 operating with a bottom region of said blister storage column 2.

The blister storage column 2 extends along a vertical axis V-V and houses a column of blisters 900 comprising a plurality of vertically stacked blisters 90, each parallel to a respective imaginary plane.

As mentioned, the blister storage column 2 comprises a bottom region 20 that is substantially open and within the column of blisters 900 there is a last blister 90a and a second-last blister 90b at said bottom region 20.

Preferably, therefore, the column of blisters 900 is suitable for being lowered, typically by means of the force of gravity, along the vertical axis V-V, within the blister storage column 2, corresponding with the unloading of a blister, in particular the last blister 90a, wherein the position thereof is taken by the second-last blister 90b.

In further other words, within the bottom region 20 there is a bottom area, wherein the last blister 90a is housed, and a pre-bottom area wherein the second-last blister 90b is housed.

According to a preferred embodiment, the blister storage column 2 has a cross-section that is substantially complementary to the blister 90. In other words, the walls of the blister storage column 2 are suitable for keeping those blisters 90 belonging to the column of blisters 900 vertically stacked.

As mentioned, the unloading system 1 comprises a pair of unloading assemblies 3 that extend and operate transversely opposed with respect to the vertical axis V-V. In other words, the two unloading assemblies 3 are reciprocally separated by the blister storage column 2 and by the column of blisters 900. In other words, the two unloading assemblies 3 are one on one side, for example to the right, and the other on the other side, for example to the left. Preferably, the two unloading assemblies 3 mirror one another in relation to the vertical axis V-V.

According to a preferred embodiment, each unloading assembly 3 extends and operates along a transverse axis X-X.

According to a preferred embodiment, the two unloading assemblies 3 extend and operate along the same transverse axis X-X.

According to the present invention, each unloading assembly 3 comprises a blade group 4 and a control group 5 operatively connected to the blade group 4 in order to move it transversely.

According to a preferred embodiment, each unloading assembly 3 comprises a plurality of blade groups 4 and a control group 5 operatively connected to the blade groups 4 in order to move them transversely.

According to the present invention, furthermore, each unloading assembly 3 also comprises a safety group 6.

According to the present invention, each blade group 4 is transversely movable along a transverse axis X-X.

The blade group 4 is preferably suitable for engaging with the last blister 90a.

In the embodiment with an unloading assembly comprising a plurality of blade groups 4, each blade group 4 is suitable for engaging with a respective blister 900 starting from the last blister 90a and from the second-last blister 90b.

According to a preferred embodiment, the plurality of blade groups 4 comprises two blade groups 41, 42 wherein one is suitable for engaging with the last blister 90a and the other is suitable for engaging with the second-last blister 90b.

In other words, the plurality of blade groups 4 comprises two blade groups 41, 42 wherein one operates within the bottom area whilst the other operates within the pre-bottom area.

According to a preferred embodiment, the plurality of blade groups 4 comprises only two blade groups 41, 42.

According to the invention, the blade group 4 comprises a movement device 412, 422 and a blade element 411, 421.

Preferably, the movement device 412, 422 is engaged at one end by the blade element 411, 412 and at the end the other end by the control group 5.

According to a preferred embodiment, the blade element 411, 412 is suitable for engaging with the respective blister 90. For example, each blade group is specially shaped to engage with the respective blister pack, for example it is shaped to insert into, and not collide with, the blister alveoli.

According to a preferred embodiment, the translatory movement of the movement device 412, 422 corresponds to a translatory movement of the blade 411, 421.

According to the present invention, the control group 5 transversely moves the movement device 412, 422. In particular, the control group 5 transversely moves the movement device 412, 422 in an alternating motion.

According to the present invention, the control group 5 transversely moves the movement devices 412, 422 alternately, in such a way that, in two vertically consecutive blade groups 4, a blade element 411, 421 is disengaged from a blister that is thus free to fall vertically, whilst the other blade element 411, 421 engages and holds the consecutive blister in a respective vertical axial position and vice versa.

According to a preferred embodiment, the pair of unloading assemblies 3 is configurable in a blister unloading configuration, wherein the last blister 90a is free to fall while the second-last blister 90b is held in a respective vertical axial position, and a blister holding configuration, wherein the last blister 90a is held in a respective vertical axial position while the second-last blister 90b is free to fall.

In other words, the unloading system 1, object of the present invention, operates in such a way as to enable the falling movement of a blister, blocking the consecutive blister. That is to say that the unloading system 1 enables the movement and unloading of the last blister 90a whilst holding the second-last blister 90b in position. Once the last blister 90a has been unloaded the movement of the second-last blister 90b is enabled which in turn becomes the last-blister 90a, i.e., it passes from the pre-bottom area to the bottom area.

In other further words, the movement of the blisters is controlled and performed by steps.

According to a preferred embodiment, the control group 5 comprises a cam device 50 that transversely moves the movement device 412, 422 that is operatively connected thereto.

According to a preferred embodiment, the movement device 412, 422 (in particular each movement device) comprises a rod element 4121, 4221 comprising a first end that is integrally connected to the blade element 411, 421 and a second end that is engageable with the cam device 50 in order to receive the transverse thrust action.

Preferably, the rod element 4121, 4221 comprises a wheel member 4121′, 4221′ suitable for engaging with the cam device 50.

According to a preferred embodiment, the movement device 412, 422 (in particular each movement device) comprises an elastically yielding element 4125, 4225 that is suitable for performing a transverse thrust action upon the rod element 4121, 4221 in order to keep it engages with the cam device 50.

Preferably, said elastically yielding element 4125, 4225 is a helical spring fitted onto the rod element 4121, 4221.

According to a preferred embodiment, the cam device 50 comprises a single cam profile that is suitable for alternately moving each movement device 412, 422.

According to a preferred embodiment, the cam device 50 comprises a plurality of cam members 51, 52 operatively connected to the respective movement device 412, 422, wherein the respective cam profiles are suitable for alternately moving the movement devices 412, 422.

According to a preferred embodiment, the cam members 51, 52 are controlled in rotation in relation to the same axis of rotation R-R.

According to a preferred embodiment, the two control groups 5, each of a respective unloading assembly 3, operate synchronously on the respective blade groups 4 by means of a drive element suitable for connecting them, such as a belt or chain, for example. In other words, according to a preferred embodiment, the unloading system 1 comprises a transmission element that connects the control groups 5 of the two unloading assemblies 3.

According to a preferred embodiment, each unloading assembly 3 comprises a safety group 6 suitable for disengaging the blade group 4 from the control group 5 in order to position it in a fixed transverse position wherein it engages with the blister.

Preferably, the safety group 6 is suitable for disengaging the blade group 4 from the control group 5, inhibiting the latter from the possibility of moving the blade group 4, positioning said blade group 4 in a fixed advanced position wherein it engages with the blister.

According to a preferred embodiment, each unloading assembly 3 comprises a safety group 6 suitable for disengaging at least one blade group 4, preferably the blade group that operates on the last blister 90a, from the control group 5 in order to position said blade group 4 in a fixed transverse position wherein it engages with the blister.

The safety group 6 is preferably suitable for disengaging the blade groups 4 from the control group 5, inhibiting the latter from the possibility of moving the blade groups 4, positioning said blade groups 4 in a fixed advanced position wherein each engages with the respective blister.

In other words, the safety group 6 disengages the blade groups 4 from the control groups 5 whereto it is therefore prevented from moving them in translation.

Preferably, said safety group 6 comprises a lever element 60 placeable in a safety position in which the action of the elastically yielding element 4125, 4225 is overcome so as to transversely move the rod element 4121, 4221 to a distal position from the control group 5.

Preferably, the lever element 60 is pneumatically movable.

Preferably, in the absence of a pneumatic supply, the lever element 60 is placeable in said safety position.

According to a preferred embodiment, the control group 5 controls the continuous movement of the cam device 50. Preferably, the action, or lack of action, of the safety group 6, enables, or does not enable, the movement of the blade devices 4.

One object of the present invention is a blister packaging machine comprising a conveyor belt and an unloading system 1 according to the characteristics described above, that is suitable for performing a singularized unloading operation of a blister 90 onto said conveyor belt.

Preferably, the blister packaging machine comprises a plurality of conveyor belts suitable for operating in parallel and a plurality of unloading systems 1, wherein each unloading system 1 is suitable for performing a singularized unloading operation of a blister 90 onto a respective conveyor belt.

According to a preferred embodiment, the blister packaging machine comprises system control means engaging the control groups 5 of the respective unloading systems 1 to control them to move in unison.

Innovatively, the unloading system and the blister packaging machine that comprises it amply fulfill the intended objective, overcoming the typical issues of the prior art.

Advantageously, the unloading system includes a safety group whereby, in the case of a possible failure, the blisters are held. Advantageously, the safety group avoids the undesired unloading of a blister.

Advantageously, the safety group includes a double safety measure: in the case of a malfunction or failure it is placed in a safety position.

Advantageously, the action of the control group is continuous.

Advantageously, in fact, the unloading system enables the achievement of all industry desires in being suitable for performing timely and precise singularized unloading operations of blisters.

Advantageously, the unloading system performs the unloading of a blister, holding the subsequent blister which therefore does not burden, with its presence and force of weight, the blister being unloaded.

Advantageously, the unloading system performs precise, guided and safe blister movements.

Advantageously, the control of the descent of the blisters is timely and certain.

Advantageously, the control of the descent of the blisters is not influenced by the number of blisters within the column of blisters.

Advantageously, the unloading system controls both the singularized unloading of the last blister and the second-last blister.

Advantageously, the unloading system performs identically reproducible movements over time.

Advantageously, the unloading system performs movements with elevated precision thereby ensuring the positioning of the respective blade devices.

Advantageously, the unloading system is extremely flexible: it is in fact extremely simple to adapt the unloading system as a function of different types of blister packs, for example modifying or replacing the blade element and/or the position thereof as a function of the shape of the blister.

Advantageously, the unloading system ensures elevated unloading speed, being suitable for performing singularized unloading operations with a periodicity of between 0.2 and 0.5 seconds, preferably 0.3 seconds.

Advantageously, the machine may be designed as a function of requirements in taking advantage of the design versatility of the unloading system.

It is clear that a person skilled in the art may make changes to the invention described above in order to meet contingent needs, which changes all fall within the scope of protection as defined in the following claims.

1. An unloading system suitable for performing a singularized unloading operation of a blister, the unloading system comprising:
i) a blister storage column extending along a vertical axis and suitable for housing a column of blisters comprising a plurality of vertically stacked blisters, each parallel to a respective imaginary plane, wherein the blister storage column comprises a bottom region in which the column of blisters comprises a last blister and a second-last blister; and
ii) a pair of unloading assemblies extending and operating transversely opposed with respect to the vertical axis, wherein each unloading assembly of the pair of unloading assemblies comprises:
a blade group transversely movable along a transverse axis and suitable for engaging the last blister, the blade group comprising a movement device and a blade element suitable for engaging a blister and engaged with one end of the respective movement device;
a control group operatively connected to another end of the movement device, which transversely moves the movement device so as to position the blade element in a position in which the blister is disengaged and free to fall vertically, and a position in which the blister is engaged and held in a respective vertical axial position; and
a safety group suitable for disengaging the blade group from the control group by positioning the blade element in a transverse position in which the blade element engages the blister.

2. The unloading system of claim 1, wherein the control group comprises a cam device engaged with the movement device, and wherein the cam device is controlled in a continuous rotary movement.

3. The unloading system of claim 1, wherein each unloading assembly of the pair of unloading assemblies comprises a plurality of blade groups movable transversely along the transverse axis each suitable for engaging a respective blister starting from the last blister and the second-last blister, and wherein the control group is operatively connected to the ends of the respective movement devices, transversely moving each movement device so as to position the respective blade elements in a position in which the blister is disengaged and free to fall vertically, and a position in which the blister is engaged and held in a respective vertical axial position.

4. The unloading system of claim 3, wherein the pair of unloading assemblies is configurable in a blister unloading configuration, in which the last blister is free to fall while the second-last blister is held in a respective vertical axial position, and a blister holding configuration, in which the last blister is held in a respective vertical axial position while the second-last blister is free to fall.

5. The unloading system of claim 2, wherein the movement device comprises a rod element comprising a first end integrally connected to the respective blade element and a second end engageable with the control group to receive a transverse thrust action, and an elastically yielding element suitable for performing the transverse thrust action on the rod element to keep the rod element engaged with the cam device.

6. The unloading system of claim 5, wherein the rod element comprises a wheel member suitable for engaging the cam device.

7. The unloading system of claim 5, wherein the safety group comprises a lever element placeable in a safety position in which the transverse thrust action of the elastically yielding element is overcome so as to transversely move the rod element to a distal position from the control group.

8. The unloading system to of claim 7, wherein the lever element is pneumatically movable and, in the absence of pneumatic supply, is placeable in the safety position.

9. The unloading system of claim 3, wherein the control group comprises a cam device engaged with the movement device, wherein the cam device is controlled in a continuous rotary movement, and wherein the cam device comprises at least one cam member rotatable about a rotation axis operatively connected to the movement devices.

10. The unloading system of claim 9, wherein the cam device comprises a plurality of cam members operatively connected to the respective movement device, wherein the cam members are rotatable with respect to the same rotation axis, and wherein respective cam profiles are suitable for alternately moving the movement devices.

11. The unloading system of claim 1, wherein the two control groups, each of a respective unloading assembly, operate synchronously on the respective blade groups by a drive element suitable for connecting the two control groups, optionally the drive element being a belt or a chain.

12. A blister packaging machine comprising a conveyor belt and the unloading system of claim 1, suitable for performing the singularized unloading operation of the blister onto the conveyor belt.

13. The blister packaging machine of claim 12, comprising a plurality of conveyor belts suitable for operating in parallel and a plurality of unloading systems, wherein each unloading system of the plurality of unloading systems is suitable for performing the singularized unloading operation of the blister onto a respective conveyor belt.

14. The blister packaging machine of claim 13, further comprising system control means engaging the control groups of the respective unloading systems to control the control groups to move in unison.

15. The unloading system of claim 1, wherein the unloading system is suitable for performing the singularized unloading operation of the blister onto a conveyor belt.

16. The unloading system of claim 3, wherein each unloading assembly of the pair of unloading assemblies comprises two blade groups.
